(19) United States
(12) Patent Application Publication
(10) Pub. No.: US 2023/0192040 A1
(43) Pub. Date: Jun. 22, 2023

(54) ELECTROHYDRAULIC BRAKE MODULE

(71) Applicant: ZF Active Safety GmbH, Koblenz (DE)

(72) Inventors: Karlheinz Schaust, Fachbach (DE); Klaus Ullmer, Koblenz (DE); Thomas Baron, Leimbach (DE); Zul Jalal Arif Ramli, Koblenz (DE); Mario Heim, Bad Hoenningen (DE); Georg Adams, Koblenz (DE)

(21) Appl. No.: 18/070,885

(22) Filed: Nov. 29, 2022

(30) Foreign Application Priority Data
Dec. 17, 2021 (DE) 102021214570.1

(51) Int. Cl. B60T 7/04; B60T 13/16; F16C 1/14

(52) U.S. Cl. CPC B60T 7/042; B60T 13/168; F16C 1/145; B60T 2270/413; B60T 2270/82; B60T 2220/04; B60T 2270/404; B60T 2270/402; B60Q 1/441

(57) ABSTRACT

The present disclosure relates to an electrohydraulic brake module for a motor vehicle brake system, comprising a housing, a hydraulic module with a piston/cylinder arrangement for generating a hydraulic brake pressure, an electric motor for driving the piston/cylinder arrangement, and a transmission arrangement for mechanically transmitting a brake pedal deflection. Furthermore, the brake module comprises a sensor cluster. The brake module has a redundantly acting sensor system and mechanism.

### CROSS-REFERENCE TO RELATED APPLICATION

This application claims priority to German Priority Application No. 102021214570.1, filed Dec. 17, 2021, the disclosure of which is incorporated herein by reference in its entirety.

### TECHNICAL FIELD

The disclosure relates to an electrohydraulic brake module for a motor vehicle brake system.

### BACKGROUND

Electrohydraulic brake modules of this type are known from the prior art. They combine the function of brake request detection, brake pressure generation of brake pressure boosting with the aid of an electric motor drive, and vehicle stability regulation, which influence the driving and braking behaviour of the vehicle during driving operation by the wheel brakes. The brake request corresponds to the brake pedal deflection which the driver of a corresponding motor vehicle brings about by way of the actuation of the brake pedal. As is known, a brake pedal of this type can be applied in one direction for brake actuation and is reset again during release of the brake pedal, that is to say during ending of the actuation. An electrohydraulic brake module of this type usually has a hydraulic block with hydraulic functional elements such as, for example, solenoid valves, connecting channels and a pump unit for generating the brake master pressure. Here, in one customary arrangement, the pump unit includes a cylinder bore which is machined in the hydraulic block and a piston which dips into the cylinder bore. The piston is driven in the axial direction via an electric motor and a rotation/translation gear mechanism, as a result of which brake fluid is displaced in the cylinder bore and brake pressure is built up. in order to open-loop or closed-loop control the respective required brake pressure, the rotor position of the rotor of the electric motor is usually detected by sensors and is evaluated electronically. Electrohydraulic brake modules of this type prevalently also have a sensor system for the electronic detection and evaluation of the brake pedal travel. Furthermore, these brake modules comprise electronic circuits, by way of which the sensor signals are processed and by way of which the above-described stability regulation arrangements are assisted or provided. Electrohydraulic brake modules of this type usually also have an electronic controller for controlling the electric motor and the solenoid valves. The indicated components are usually joined together to form one modular unit. The electronic controllers and the electric motor are usually encapsulated by way of one or more housings.

Brake functions have to be provided such that they operate exactly and are redundant. If, in the case of the failure of a brake module or individual functions within the brake module, a direct mechanical intervention by the brake pedal on a pressure-generating piston/cylinder unit takes place as fall-back option, considerable functional losses can be associated with this. The functional failure in an electrohydraulic brake module can also impair driving stability systems or render them inoperative. In general, the available installation space in motor vehicles is highly limited. Voluminous brake modules are therefore difficult to install in most cases.

### SUMMARY

What is needed is to improve the electrohydraulic brake module with regard to reliability and handling.

In accordance with a first aspect of the disclosure, an electrohydraulic brake module is provided for a motor vehicle brake system. A motor vehicle brake system of this type has a brake pedal, by way of which a brake request is transmitted to the electrohydraulic brake module by way of actuation. The transmission takes place by a mechanical connection which transmits a deflection of the brake pedal to the electrohydraulic brake module. Starting from the electrohydraulic brake module, a brake pressure distribution takes place in the motor vehicle brake system towards the wheel brakes.

The electrohydraulic brake module in accordance with a first aspect of the disclosure comprises a housing, a hydraulic module with a piston/cylinder arrangement for generating a hydraulic brake pressure, an electric motor for driving the piston/cylinder arrangement, a transmission arrangement for mechanically transmitting a brake pedal deflection, a pedal travel transducer arrangement which is coupled to the transmission arrangement and is guided or mounted in the housing, with a first mechanism element and a second mechanism element, a printed circuit board which is connected to the housing, with a sensor duster which has a pedal travel sensor arrangement.

The pedal travel transducer arrangement has a first pedal travel transducer. The pedal travel sensor arrangement has a first pedal travel sensor. The first pedal travel transducer and the first pedal travel sensor together form a first pedal travel detection unit which electronically detects the brake pedal deflection during operation. The pedal travel transducer arrangement has a second pedal travel transducer. The pedal travel sensor arrangement having a second pedal travel sensor. The second pedal travel transducer and the pedal travel sensor together form a second pedal travel detection unit which electronically detects the brake pedal deflection during operation in a redundant manner with respect to the first pedal travel detection unit. The first mechanism element establishes a force flow between the transmission arrangement and the housing in the case of a brake pedal actuation, and the second mechanism element establishes a force flow between the transmission arrangement and the housing in a redundant manner with respect to the first mechanism element in the case of a brake pedal actuation.

The piston/cylinder arrangement acts as a brake master cylinder, by which brake fluid is fed into a motor vehicle brake system during operation. In one exemplary arrangement, a corresponding piston dips into a cylinder bore which is made in the hydraulic module and forms a pressure space, and displaces brake fluid out of the precious space into the motor vehicle brake system during operation in the case of brake actuation. In one exemplary arrangement, the piston is driven by way of the electric motor via a rotation/translation gear mechanism. In terms of the operating principle, the rotation/translation gear mechanism is a nut/spindle mechanism and, in one exemplary arrangement, a ball screw drive. In one exemplary arrangement, the housing is connected fixedly to the hydraulic module.

A sensor cluster is to be understood to mean a spatially concentrated arrangement of a plurality of sensors. Sensor arrangements can have a sensor component such as, for example, conductor coils, semiconductors, electrodes together with application-specific integrated circuits (ASIC).

If it is stated that the first and/or the second mechanism element establish/establishes a force flow between the transmission arrangement and the housing in the case of a brake pedal actuation, this means that the mechanism elements are such, and are installed such, that they can transmit forces and/or movements. The respective force flow between the transmission arrangement and the housing does not have to be established here exclusively via the respective mechanism element alone. That is to say, further components can in each case also participate in the establishing of the respective force flow.

The first pedal travel detection unit is configured to fulfil its function during normal operation of the electrohydraulic brake module. This is the case when the corresponding components are functioning without disruptions. The first pedal travel detection unit is such that, in the case of a brake actuation, the first pedal travel transducer moves relative to the first pedal travel sensor. An application-specific integrated circuit which is contained in the sensor arrangement can assist the electronic detection of a relative movement of this type and therefore also the electronic detection of a brake pedal deflection.

The second pedal travel detection unit is configured to function in a redundant manner with respect to the first pedal travel detection unit. In the case of a functional failure of the first pedal travel detection unit, the second panel travel detection unit assumes the detection of the brake pedal deflection. The second pedal travel detection unit is such that, in the case of a brake actuation, the second pedal travel transducer moves relative to the second pedal travel sensor. An application-specific integrated circuit which is contained in the sensor arrangement can assist the electronic detection of a relative movement of this type and therefore also the electronic detection of a brake pedal deflection.

The second pedal travel detection unit ensures failsafe operation of the electrohydraulic brake module. In the case of a functional disruption in the first pedal travel detection unit, the second pedal travel detection unit can maintain the function of the electrohydraulic brake module without or, depending on the specific design, with low brake function impairment. In the case of a mechanical functional disruption which concerns the first mechanism element, the second mechanism element can likewise maintain the function of the electrohydraulic brake module. The electrohydraulic brake module is safeguarded in a redundant manner by way of this exemplary arrangement on an electrical level and on a mechanical level

The pedal travel transducer arrangement comprises a guide element which is coupled to the transmission arrangement and which is operatively connected to the first and the second mechanism element and establishes a force flow between the transmission arrangement and the housing.

In one exemplary arrangement, the guide element is guided such that it can be moved linearly in the housing, and it supports the first and the second pedal travel transducer. The transmission arrangement has a thrust rod which is guided such that it can be moved linearly, acts on the guide element with a thrust force in the case of a brake pedal actuation, and is connected via a connecting point to the guide element in such a way that a thrust movement of the thrust rod can be forwarded into a linear movement of the guide element. The first and the second mechanism element are in each case a spring which acts between the housing and the guide element with a restoring force which acts counter to the thrust force. In one exemplary arrangement, it is in each case a tension spring. The springs are arranged in each case in such a way that their lines of action run parallel to the linear movement direction of the guide element. The first spring is designed to reset the guide element. The second spring assists the resetting function. In the case of a failure of the first spring, example in the case of a spring fracture, the second spring fulfils the restoring function in a redundant manner and therefore improves the failed safety and reliability of the electrohydraulic brake module.

In one exemplary arrangement, the first spring, and in another exemplary arrangement, the first and the second spring, is/are prestressed in the rest position of the guide element.

The rest position of the guide element is that position, in which, during operation of the electrohydraulic brake module, the brake is not actuated by way of a brake pedal deflection, and therefore the guide element is also not deflected by way of a brake actuation. A possible play in the connecting point is eliminated by way of the prestressed, as a result of which a brake pedal deflection can be electronically detected exactly.

In one exemplary arrangement, the first and the second pedal travel detection unit have sensor technologies which differ from one another. As a result, the risk of mutual disruptive influences of the detection units in the sensor cluster is reduced. In the case of one possible diverse refinement, the first pedal travel detection unit is a pedal travel detection unit which detects in accordance with the inductive sensor principle, and the second pedal travel detection unit is a pedal travel detection unit which detects in accordance with the Hall sensor principle. The inductive sensor principle has a high interference immunity against external magnetic fields and provide safe redundancy together with the Hall sensor principle of the second pedal travel detection unit. In the case of a further possible diverse refinement, the first pedal travel detection unit is a pedal travel detection unit which detects in accordance with the Hall sensor principle, and the second pedal travel detection unit is a pedal travel detection unit which detects in accordance with the inductive sensor principle.

As an alternative to the use of differing sensor technologies, the first and the second pedal travel detection unit can also have sensor technologies which are homogeneous with respect to one another. In the case of one possible homogeneous refinement, the first and the second pedal travel detection unit are in each case a pedal travel detection unit which detects in accordance with the inductive sensor principle. In the case of a further homogeneous refinement, the first and the second pedal travel detection unit are in each case a pedal travel detection unit which detects in accordance with the Hall sensor principle.

In one alternative refinement to the exemplary arrangement with a guide element which can be moved in the housing linearly, the guide element is of annular configuration (also called a ring form variant in the following text) and is mounted rotatably in the housing. In one exemplary arrangement, the annular guide element has a gearwheel toothing system at least in sections. It is an external gearwheel toothing system. In this case, the transmission arrangement has a push/pull rod which is guided such that it can be moved linearly and acts alternately with a thrust and pulling force on the guide element in the case of a brake pedal actuation. This push/pull rod is connected via a connecting point to the annular guide element in such a way that a thrust movement of the push/pull rod is converted into a rotational movement of the guide element. The first and the second mechanism element are in each case of wheel-shaped configuration, with a gearwheel external toothing system, and are mounted in each case in a stationary and a rotatable manner in the housing, in one exemplary arrangement, in a stationary and a rotatable manner in the housing, such as with the aid of a cover element. The first and the second mechanism element are positioned next to one another in the housing in such a way that they in each case form a gear mechanism, for example a gearwheel mechanism, with the guide element of annular configuration and its gearwheel toothing system. The first mechanism element supports the first pedal travel transducer, and the second mechanism element supports the second pedal travel transducer.

An alternately acting thrust and pulling force is brought about during operation of the electrohydraulic brake module in the case of a brake actuation by way of a brake pedal deflection. A thrust force is brought about during pressing of a brake pedal, and a pulling force is brought about by way of releasing of the brake pedal. In the case of a functional disruption of the first mechanism element which may be a driven gearwheel here, the second mechanism element which likewise may be a driven gearwheel available in a redundant manner.

In the case of the ring form variant, the connecting point is such that, together with the push/pull rod, it forms a cross-slider crank mechanism. The crossslider crank mechanism is configured in such a way that the annular guide element has a slotted guide and the push/pull rod has a pin which is guided in the slotted guide. In the present case, the cross-slider crank mechanism operates in such a way that the push/pull rod drives the annular guide element. The pin can be configured, for example, as a pin which is fastened to the end of the push/pull rod. The annular guide element forms, as it were, a motion link with a slotted guide. This slotted guide can be configured as a slot. In the case of an actuation of the push/pull rod, driving of the annular guide element takes place via the pin which is guided in the slotted guide. This exemplary arrangement of the connecting point provides a reliably operating transmission of force and movement.

In the case of the ring form variant, the first and the second pedal travel detection unit are in each case a pedal travel detection unit which detects in accordance with the magneto-resistive sensor principle. The angular positions of the mechanism elements can be detected very precisely by way of this sensor principle, which leads to a reliable function of the electrohydraulic brake module.

In accordance with a second aspect of the disclosure, the electrohydraulic brake module comprises a housing, a hydraulic module with a piston/cylinder arrangement for generating a hydraulic brake pressure, an electric motor for driving the piston/cylinder arrangement, a transmission arrangement for mechanically transmitting a brake pedal deflection, a pedal travel transducer arrangement which is coupled to the transmission arrangement and is guided or mounted in the housing, with a first mechanism element and a second mechanism element, a printed circuit board which is connected to the housing, with a sensor cluster which has a pedal travel sensor arrangement. The pedal travel transducer arrangement has a pedal travel transducer and the pedal travel sensor arrangement has a first pedal travel sensor. The pedal travel transducer and the first pedal travel sensor together forming a first pedal travel detection unit which electronically detects the brake pedal deflection during operation. The pedal travel sensor arrangement has a second pedal travel sensor, the pedal travel transducer and the second pedal travel sensor together forming a second pedal travel detection unit which electronically detects the brake pedal deflection in a redundant manner with respect to the first pedal travel detection unit during operation. The first mechanism element establishes a force flow between the transmission arrangement and the housing in the case of a brake pedal actuation, and the second mechanism element establishes a force flow between the transmission arrangement and the housing in a redundant manner with respect to the first mechanism element in the case of a brake pedal actuation.

Since, in the case of this second aspect of the disclosure, the electrohydraulic brake module differs only slightly from that of the first aspect of the disclosure, reference is made to the above-described details and advantages of the electrohydraulic brake module according to the disclosure which also apply to the electrohydraulic brake module in accordance with the second aspect of the disclosure. By virtue of the fact that, in the case of the electrohydraulic brake module in accordance with the second aspect of the disclosure, only one pedal travel transducer is necessary, by way of which, however, there is nevertheless the electronic redundancy function together with the first and the second pedal travel sensor, cost advantages and a greater robustness as a result of fewer individual components result.

In the case of the second aspect of the disclosure, the pedal travel transducer arrangement comprises a guide element which is coupled to the transmission arrangement, and which is operatively connected to the first and the second mechanism element and establishes a force flow between the transmission arrangement and the housing.

In one exemplary refinement in the case of the second aspect of the disclosure, the guide element is guided in the housing such that it can be moved linearly, and it supports the pedal travel transducer. The transmission arrangement is a thrust rod which is guided such that it can be moved linearly, acts with a thrust force on the guide element in the case of a brake pedal actuation, and is connected via a connecting point to the guide element in such a way that a thrust movement of the thrust rod can be forwarded into a linear movement of the guide element. The first and the second mechanism element are in each case a spring which acts between the housing and the guide element with a restoring force which acts counter to the thrust force. In one exemplary arrangement, they are in each case a tension spring. The springs are arranged in each case in such a way that their lines of action run parallel to the linear movement direction of the guide element. The first spring is designed to reset the guide element. The second spring assists the resetting function. In the case of a failure of the first spring, for example in the case of a spring fracture, the second spring fulfils the resetting function in a redundant manner, and therefore improves the failsafe operation of the electrohydraulic brake module.

In the case of the second aspect of the disclosure, the first and the second pedal travel detection unit have sensor technologies which are homogeneous with respect to one another. It is possible that the first and the second pedal travel detection unit are in each case a pedal travel detection unit which detects in accordance with the inductive sensor principle. It is also possible that the first and the second pedal travel detection unit are in each case a pedal travel detection unit which detects in accordance with the Hall sensor principle and in the case of which the pedal travel transducer is a permanent bipolar magnet. As has already been mentioned, the use of homogeneous sensor technologies of this type has the effect of reducing the number of individual parts, as a result of which the electrohydraulic brake module becomes more robust. It is also possible that the first and the second pedal travel detection unit are in each case a pedal travel detection unit which detects in accordance with the Hall sensor principle and in the case of which the pedal travel transducer is a permanent multipolar magnet. This results in satisfactory travel resolution and therefore an exact detection of the brake pedal deflection, which improves the reliability of the electrohydraulic brake module.

Within the context of the second aspect of the disclosure with a homogeneous sensor technology in relation to the first and second pedal travel detection unit, the first and the second pedal travel detection unit can also in each case be a pedal travel detection unit which detects in accordance with the Hall sensor principle, and the pedal travel transducer can be a permanent bipolar magnet. Here, the first pedal travel sensor has two individual sensors which are arranged in a row in the movement direction of the pedal travel transducer arrangement, and it is possible for the first pedal travel sensor to detect a greater movement travel of the pedal travel transducer arrangement than the second pedal travel sensor. The individual sensors which are arranged in a row in the movement direction of the pedal travel transducer arrangement are advantageously arranged spaced apart from one another. As a result of the use of the two individual sensors which are arranged in a row, a greater movement travel of the pedal travel transducer can be detected, which leads to higher resolution of the pedal travel detection and therefore to a more reliable actuation of the electric motor and therefore to exact and reliable hydraulic brake pressure generation. In one exemplary arrangement, the first and the second pedal travel sensor can be arranged so as to follow one another in a row in the movement direction of the pedal travel transducer arrangement. The second pedal travel sensor is not divided into further individual sensors. The second pedal travel sensor is arranged so as to directly follow a first individual sensor of the first pedal travel sensor and so as to be spaced apart from a second individual sensor of the first pedal travel sensor. The arrangement in a row can also be in a sequence such that the second pedal travel sensor is arranged first in the thrust direction, immediately followed by a first individual sensor of the first pedal travel sensor and, spaced apart from the first individual sensor of the first pedal travel sensor, a second individual sensor of the first pedal travel sensor. The second pedal travel sensor as individual unit can therefore detect only a small movement travel of the pedal travel transducer than the first pedal travel sensor with its at least two individual sensors which are arranged in a row in the movement direction of the pedal travel transducer arrangement. Since the second pedal travel detection unit fulfils a redundancy function, this is possible. The controller of the electrohydraulic brake module is designed in such a way that, in the case of activation of the redundancy function in the case of this exemplary refinement with the different detection travel lengths of the movement travels of the pedal travel transducer, the actuation of the electric motor switches over in accordance with the shortened detection length by way of the second pedal travel detection unit, with the result that a brake actuation can nevertheless take place in a sufficient way. In the case of this refinement, the electronic redundancy function is ensured with an exemplary arrangement which is simultaneously less expensive but also more robust as a result of fewer components.

The refinements of the disclosure mentioned in the following text can be combined among one another and with all abovementioned aspects and possible or preferred refinements of the disclosure.

The electrohydraulic brake module has a rotor position transducer arrangement with a rotor position transducer, the sensor duster having a rotor position sensor arrangement with a rotor position sensor, and the rotor position transducer and the rotor position sensor together forming a rotor position detection unit which electronically detects the rotor position of the rotor of the electric motor during operation. The rotor position detection unit is a rotor position detection unit which detects in accordance with the inductive sensor principle. As an alternative, a rotor position detection unit can also be provided which operates in accordance with another sensor principle, for example a rotor position detection unit which operates in accordance with a magnetic sensor principle, for example, the magneto-resistive sensor principle.

In one exemplary refinement, the rotor position sensor arrangement is arranged on a first side of the printed circuit board, and the pedal travel sensor is arranged on a second side of the printed circuit board, which second side lies opposite the first side.

In one exemplary arrangement, the sensor cluster comprises a microswitch. In one exemplary arrangement, it is a microswitch with a switching lever or with a roller lever. As an alternative, the microswitch can be a reed switch or another switch which responds to a magnetic field. The microswitch or the stated types of microswitch is/are suitable for activating the electrohydraulic brake module and/or other systems in a vehicle from a system rest state and/or it or they is/are suitable for activating a vehicle brake light. The microswitch is arranged on the second side of the printed circuit board.

The combination of the various sensors in a sensor duster and also of the microswitch and likewise the stated arrangement of components on the first and second side of the printed circuit board result in installation space advantages and therefore in improved handling of the electrohydraulic brake module in the case of the design of a passenger car engine compartment or else an entire passenger car. The combination into a sensor duster also results in fewer connector interfaces, which leads to higher reliability.

The pedal travel transducer arrangement, for example the guide element, has a mechanical switching section or a magnet, in order for it to be possible for the microswitch to be switched in the case of a brake pedal actuation.

In one exemplary refinement, the electrohydraulic brake module, for example the printed circuit board, has an electronic interface for transmitting digital signals to an electronic control unit, such as to an electronic control unit for controlling the electric motor. An electronic interface of this type contributes to secure data transmission and therefore to the reliability of the electrohydraulic brake module. As a result, the electrohydraulic brake module is also of more compact design and has an improved handling capability.

### BRIEF DESCRIPTION OF DRAWINGS

Further features, advantages and possible applications of the present disclosure result from the following description of the exemplary arrangements and the diagrammatic figures. For the sake of clarity, all the illustrated elements in figure are not necessarily provided with a reference numeral. Corresponding elements or regions are then labelled at least in another figure, however, and the meaning can be gathered from there. Furthermore, identical reference numerals in the figures stand for identical or similar objects.

FIG. 1 shows the entire construction of an electrohydraulic brake module according to the disclosure,

FIG. 2 shows a sectional illustration of a hydraulic module; the piston/cylinder arrangement is merely indicated by way of a bordered region,

FIG. 3 shows the printed circuit board with the sensor cluster, and a pedal travel transducer arrangement in an indicated manner,

FIG. 4 perspectively shows one example of an arrangement of the guide element, and further elements,

FIG. 5 shows a parallel projection of a detail from FIG. 4,

FIG. 6 shows a parallel projection of a further example of an arrangement of the guide element, and further elements,

FIG. 7 shows the exemplary arrangement according to FIG. 6 in an exploded illustration,

FIG. 8 shows an exploded illustration of one variant of a first aspect of the disclosure,

FIG. 9 shows a block diagram of one variant of a first aspect of the disclosure,

FIG. 10 shows an exploded illustration of one variant of a first aspect of the disclosure,

FIG. 11 shows a block diagram of one variant of a first aspect of the disclosure,

FIG. 12 shows an exploded illustration of one variant of a second aspect of the disclosure,

FIG. 13 shows a block diagram of one variant of a second aspect of the disclosure,

FIG. 14 shows an exploded illustration of variants of the second aspect of the disclosure,

FIG. 15 shows a block diagram of one variant of a second aspect of the disclosure, and

FIG. 16 shows a block diagram of one variant of a second aspect of the disclosure.

### DETAILED DESCRIPTION

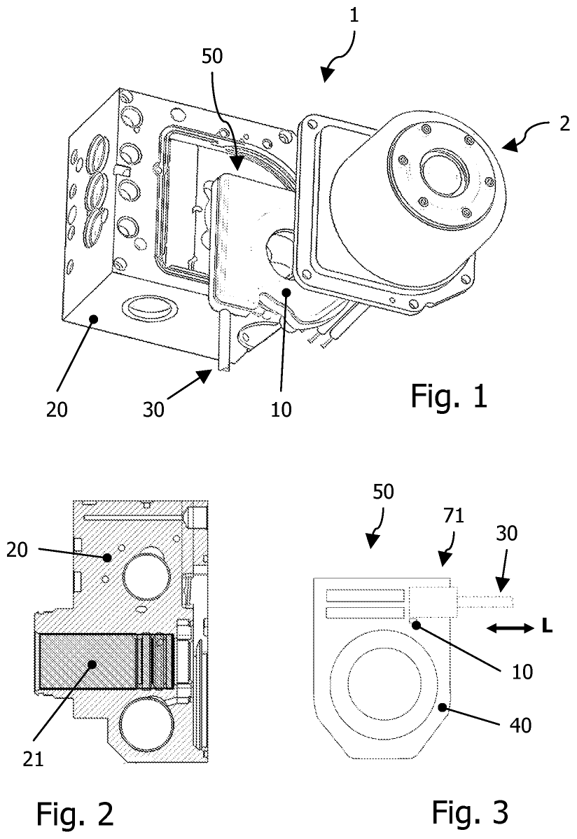

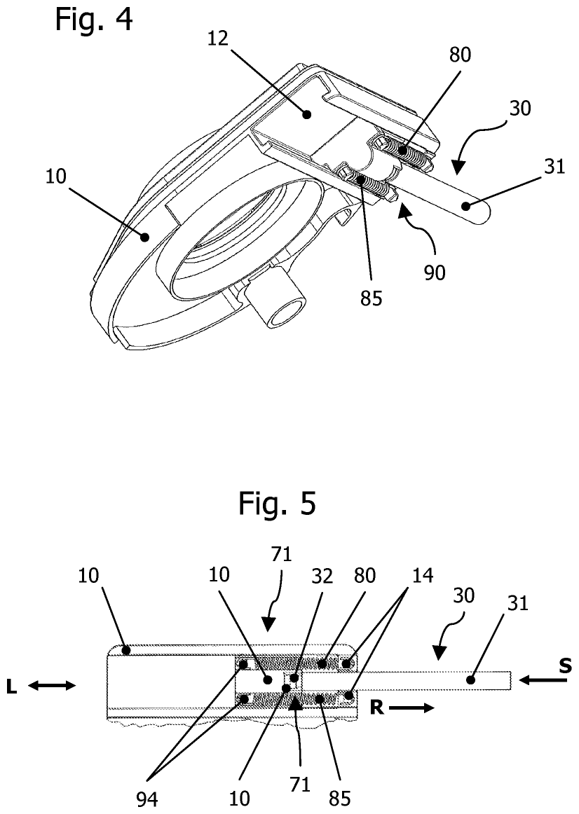

FIGS. 1 to 3 illustrate by way of example the basic construction of an electrohydraulic brake module 1 (called a brake module in the following text) according to the disclosure with its basic constituent parts which are labelled by way of reference numerals. This basic construction is also found in the aspects and variants of the disclosure which are shown from FIG. 4, and/or applies to them. The brake module 1 has a hydraulic module 20 and an electric motor 2. The electric motor 2 is connected to the hydraulic module 20. The printed circuit board 40 which is shown in FIG. 3 is situated between the electric motor 2 and the hydraulic module 20 in a housing 10. The printed circuit board comprises a sensor cluster 50. The transmission arrangement 30 which is coupled to the pedal travel transducer arrangement 71 reaches into the housing 10. The piston/cylinder arrangement 21 for generating a hydraulic brake pressure is shown in FIG. 2 merely as a hatched region with a rectangular border. In one exemplary arrangement, the drive of the piston in order to build up pressure and in order to displace brake fluid takes place by a rotation/translation mechanism (not shown) which is a nut/spindle mechanism, for example a ball screw drive. This rotation/translation mechanism is connected between the electric motor 2 and the piston/cylinder arrangement 21.

FIGS. 4 and 5 show one example of a mechanical exemplary arrangement of the disclosure, in the case of which the pedal travel transducer arrangement 71 is guided linearly. In the following text, this possible exemplary arrangement is also called a linear guide configuration for improved readability. In the case of this configuration, the pedal travel transducer arrangement 71 comprises a guide element 90 which is configured as a slide and is guided in the housing such that it can be moved linearly, that is to say is guided translationally. This linear movement direction is labelled by “L” in FIG. 5. In order to achieve the guide function, the housing 10 has a guide channel 12, in which the guide element 90 is guided. The guide element 90 is coupled to the transmission arrangement 30 via a connecting point 34, and can correspondingly be moved linearly by way of the transmission arrangement 30. The transmission arrangement 30 comprises a thrust rod 31 with a head part 32. The guide element 90 has a receptacle 93 which receives the head part 32. The receptacle 93 and the head part 32 form the connecting point 34, and make a force and movement transmission between the thrust rod 31 and the guide element 90 possible. Two tension springs 80, 85 are installed in a prestressed state between the guide element 90 and the housing 10. The direction of action is oriented in each case parallel to the linear movement direction L, The tension springs are fastened by way of their holding eyes in each case to corresponding receiving pins 14, 94 of the housing 10 and the guide element 90. The tension spring 80 forms the first mechanism element 80, and the tension spring 85 forms the second mechanism element 85. In the case of a displacement of the guide element 90 which can be brought about by way of a brake pedal actuation and transmission of force by way of the thrust rod 31, the tension springs 80, 85 exert a resetting force R counter to the thrust force S on the guide element 90, In the prestressed state, the tension springs 80, 85 eliminate a possible play in the connecting point 34. This leads to reliable operation of the brake module 1. A play in the connecting point 34 can falsify the pedal travel detection in contrast. The tension springs 80, 85 act in such a way that the prestress and also the resetting action are achieved only by way of one of the tension springs 80, 85. Therefore, the tension springs are of redundant design, and one of the two tension springs forms a mechanism element with a redundant action. In the case of a failure, for example a spring fracture, of one of the two tension springs 80, 85, the correspondingly remaining intact tension spring assumes the full function. This leads to a reliable, safeguarded function of the brake module 1.

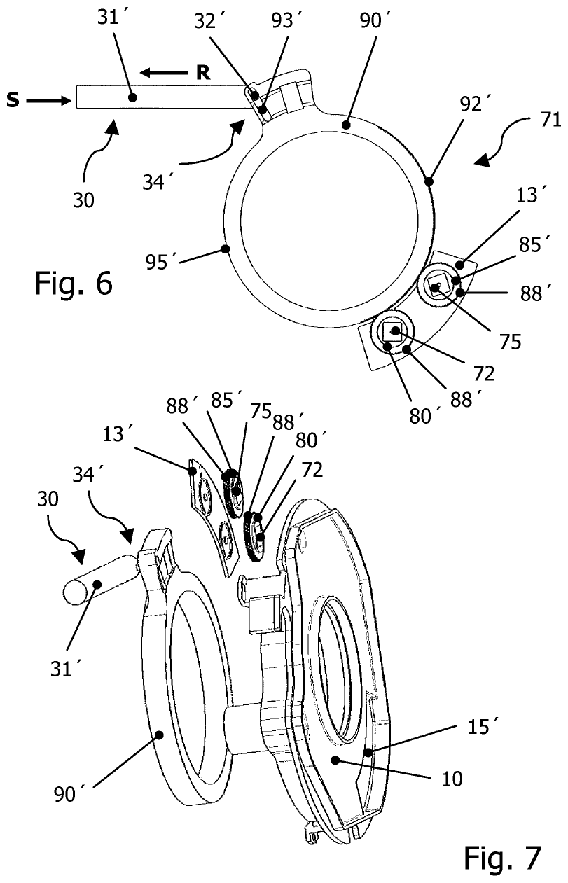

FIGS. 6 and 7 show a further example of a mechanical exemplary arrangement of the disclosure, in the case of which the pedal travel transducer arrangement 71 comprises a guide element 90′ which is configured as a ring and which is mounted in the housing 10 such that it can be moved rotationally. In the following text, on account of improved readability, this possible exemplary arrangement will also be called a rotary bearing configuration, A slotted guide 93′ in the form of a slot is made on a projection 91′ of the ring 90′. The transmission arrangement 30 comprises a push/pull rod 31′ which has a pin 32′ at its end, The pin 32′ is guided in the slotted guide 93′, with the result that the linear thrust or pulling movement of the push/pull rod 31′ is transformed into a rotational movement of the guide element 90′. This corresponds to the operating principle of a cross-slider crank mechanism. The ring 90′ has a gearwheel toothing system 92′ on its outer circumference. The gearwheel toothing system 92′ extends over at most 50% of the outer circumference 95′ of the ring 90′. Two gearwheels 80′, 85′ with in each case one external toothing system which form the first and the second mechanism element 80′, 85′ are likewise mounted rotatably in the housing 10, for example in a housing pocket 15′, Furthermore, a cover element 13′ fixes the position of the gearwheels 80′, 85′ in the housing 10. The gearwheels 80′, 85′ are positioned in such a way that they are in meshing engagement with the gearwheel toothing system 92′ of the ring 90′ and can be driven by way of the ring 90′. The gearwheels 80′, 85′ are arranged spaced apart from one another along the gearwheel toothing system 92′ of the ring 90′, with the result that they are driven at the same time in the case of a rotation of the ring 90′ but are in engagement in each case with a different region of the gearwheel toothing system 92′. Therefore, one of the two gearwheels 80′, 85′, that is to say of the two mechanism elements 80′, 85′ has a redundant effect, which brings about a reliable function of the brake module 1. The gearwheels 80′, 85′ in each case support a pedal travel transducer. As a result, a rotation of the gearwheels 80′, 85′ is transmitted to the respective pedal travel transducer, The pedal travel transducers with the above-described mechanism (ring 90′, gearwheels 80′, 85′) together form the pedal travel transducer arrangement 71 The gearwheel 80′ is a first gearwheel and supports the first pedal travel transducer 72. The gearwheel 85′ is a second gearwheel and supports a second pedal travel transducer 75.

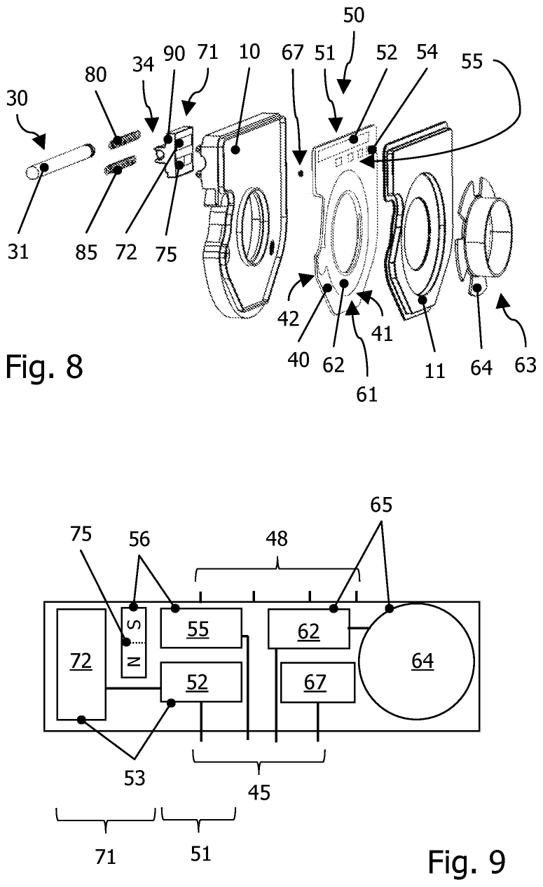

FIGS. 8 and 9 show one variant of the first aspect of the disclosure. In the case of this variant, the above-described linear guide configuration comes into effect, The guide element 90 supports a first pedal travel transducer 72 and a second pedal travel transducer 75. The first pedal travel transducer 72 is a metal target, The second pedal travel transducer 75 is a permanent bipolar magnet. A printed circuit board 40 is attached on or in the housing 10, a first side 41 of the printed circuit board 40 facing the pedal travel transducer arrangement 71, and a second side 42 which lies opposite the first side 41 facing away from the pedal travel transducer arrangement 71. The printed circuit board 40 is encapsulated with respect to the surrounding area by way of a housing cover 11. The housing cover 11 therefore faces the first side 41 of the printed circuit board 40. A rotatable rotor position transducer arrangement 63 which is configured as a metal target is situated such that it is embedded partially rotationally movably into the outer side of the housing cover 11 or is positioned rotationally movably directly on the outer side of the housing cover 11. The rotor position transducer arrangement 63 comprises a plurality of rotor position transducers 64 which are formed from metal portions which are spaced apart from one another and are arranged in a star-shaped manner. In one exemplary arrangement, each have the shape of a circular ring sector. This construction of the rotor position transducer 64 with a corresponding sensor system ensures a precise and failsafe detection of the rotor position of the electric motor 2. The printed circuit board 40 has a sensor duster 50 which comprises a pedal travel sensor arrangement 51 and a rotor position sensor arrangement 61.

The rotor position sensor arrangement 61 is arranged on the first side 41 of the printed circuit board 40, and the pedal travel sensor arrangement 51 is arranged on the second side 42 of the printed circuit board 40. The rotor position sensor arrangement 61 has a rotor position sensor 62. The rotor position sensor 62 and the rotor position transducer 64 together form a rotor position detection unit 65 which operates in accordance with the inductive sensor principle. The rotor position sensor 62 correspondingly has transmitting and receiving coils. An integrated circuit belonging to the rotor position sensor 62 is contained on the printed circuit board 40.

The pedal travel sensor arrangement 51 has a first pedal travel sensor 52 and a second pedal travel sensor 55. The first pedal travel sensor 52 and the first pedal travel transducer 72 together form a first pedal travel detection unit 53 which operates in accordance with the inductive principle. The first pedal travel sensor 52 accordingly has transmitting and receiving coils. An integrated circuit belonging to the pedal travel sensor 52 is contained on the printed circuit board 40. The second pedal travel sensor 55 and the second pedal travel transducer 75 together form a second pedal travel detection unit 56 which operates in accordance with the Hall principle. The second pedal travel sensor 55 accordingly has an electrode arrangement for utilizing the Hall effect. An integrated circuit belonging to the pedal travel sensor 55 is contained on the printed circuit board 40. In this case, the pedal travel sensor 55 is formed by way of a plurality of (at least two) individual sensors 54, in order to detect a displacement of the second pedal travel transducer 75.

The second pedal travel detection unit 56 forms a unit, redundant with respect to the first pedal travel detection unit 53, for the detection of a pedal deflection. Therefore, the brake module 1 operates reliably even if the first pedal travel detection unit 53 should fail during operation. The brake module 1 can also be designed in such a way that the first pedal travel detection unit 53 operates in accordance with the Hall principle and the second pedal travel detection unit 56 operates in accordance with the inductive principle. In this case, the pedal travel detection unit which operates in accordance with the inductive principle would be the redundant unit.

Furthermore, the printed circuit board 40 has a microswitch with a roller lever 67, by way of which, for example, a brake light of an associated vehicle can be activated and deactivated, or one or more systems, for example, the electronic controller of the brake module 1, can be activated from a rest state. The connectors 48 in FIG. 9 provide the power supply and the grounding. The connectors 45 provide the interface for the output of measured signals. This interface may be configured as a digital interface. The digital interface provides functional reliability with a compact overall design. This results in satisfactory handling of the brake module 1. The first and the second pedal travel sensor 52, 55 are arranged next to one another, for example oriented at a spacing from one another in each case along parallel to the linear movement direction L of the guide element 90, with the result that they can detect a linear movement of the guide element 90 or of the pedal travel transducers 72, 75. The first pedal travel transducer 72 is correspondingly arranged in such a way that it moves along the first pedal travel sensor 52 in the case of a linear movement of the guide element 90, and the second pedal travel transducer 75 is arranged in such a way that it moves along the second pedal travel sensor 55 in the case of a linear movement of the guide element 90.

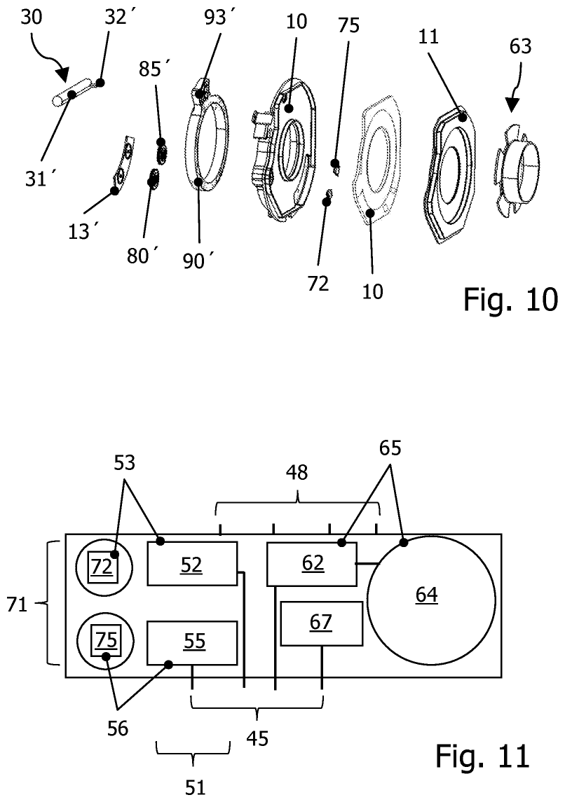

FIGS. 10 and 11 show a further variant of a first aspect of the disclosure. In the case of this variant, the above-described rotary bearing configuration comes into effect. The pedal travel transducer arrangement 71 comprises the first pedal travel transducer 72 and the second pedal travel transducer 75. The first pedal travel transducer 72 is arranged on the first gearwheel 80′ and is configured as a permanent magnet. The second pedal travel transducer 75 is arranged on the second gearwheel 85′ and is configured as a permanent magnet. The arrangement, the construction and the type of printed circuit board 40, connectors 45, 48, housing cover 11, microswitch 67, rotor position sensor arrangement 61 and rotor position transducer arrangement 63 and the method of operation of the rotor position detection unit 65 are identical to the variant described above on the basis of FIGS. 8 and 9, and have the same effects and advantages in relation thereto. The pedal travel sensor arrangement 51 has a first pedal travel sensor 52 and a second pedal travel sensor 55. The first pedal travel sensor 52 and the first pedal travel transducer 72 together form a first pedal travel detection unit 53 which operates in accordance with the magnetoresistive sensor principle. The first pedal travel sensor 52 has a corresponding construction. An integrated circuit belonging to the pedal travel sensor 52 is contained on the printed circuit board 40. The second pedal travel sensor 55 and the second pedal travel transducer 75 together form a second pedal travel detection unit 56 which operates in accordance with the magneto-resistive sensor principle. The second pedal travel sensor 55 has a corresponding construction. An integrated circuit belonging to the pedal travel sensor 55 is contained on the printed circuit board 40.

The second pedal travel detection unit 56 forms a unit, redundant with respect to the first pedal travel detection unit 53, for the detection of a pedal deflection. Therefore, the brake module 1 operates reliably even if the first pedal travel detection unit 53 should fail during operation. The brake module 1 can also be designed in such a way that the first pedal travel detection unit 53 is the redundant unit.

The first and the second pedal travel sensor 52, 55 are arranged on the printed circuit board 40 next to one another and at a spacing from one another in such a way that they can detect a rotation of the gear wheels 80′, 85′ or the pedal travel transducers 72, 75. That is to say, the first gearwheel 80′ is arranged together with the first pedal travel transducer 72 in such a way that its rotation can be detected by way of the first pedal travel sensor 52, and the second gearwheel 85′ is arranged together with the second pedal travel transducer 75 in such a way that its rotation can be detected by way of the second pedal travel sensor 55.

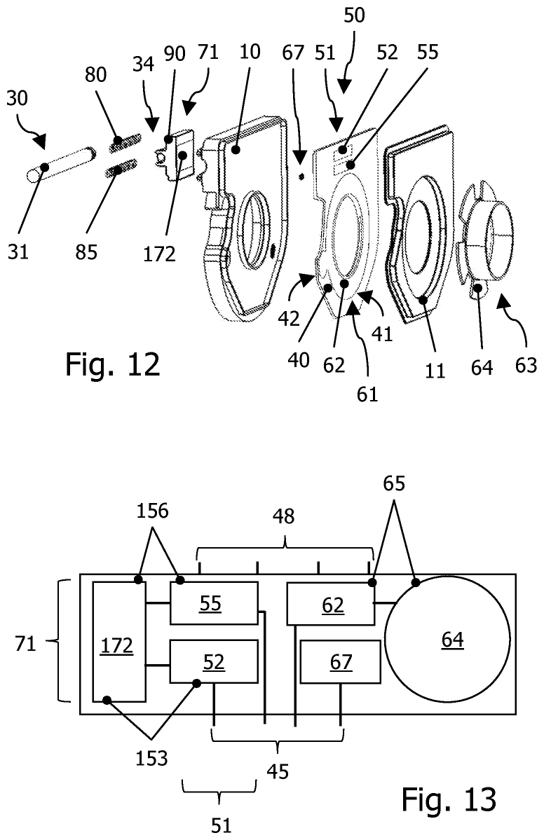

FIGS. 12 and 13 show one variant of a second aspect of the disclosure. In the case of this variant, the above-described linear guide configuration comes into effect. The guide element 90 supports a pedal travel transducer 172. The pedal travel transducer 172 is a metal target. The arrangement, the construction and the type of printed circuit board 40, connectors 45, 48, housing cover 11, microswitch 67, rotor position sensor arrangement 61 and rotor position transducer arrangement 63 and the method of operation of the rotor position detection unit 65 are identical to the variant described above on the basis of FIGS. 8 and 9, and have the same effects and advantages in relation thereto. The pedal travel sensor arrangement 51 has a first pedal travel sensor 52 and a second pedal travel sensor 55. The first pedal travel sensor 52 and the pedal travel transducer 172 together form a first pedal travel detection unit 153 which operates in accordance with the inductive principle. The first pedal travel sensor 52 accordingly has transmitting and receiving coils. An integrated circuit belonging to the pedal travel sensor 52 is contained on the printed circuit board 40. The second pedal travel sensor 55 and the pedal travel transducer 172 together form a second pedal travel detection unit 156 which operates in accordance with the inductive principle. The first pedal travel sensor 52 accordingly has transmitting and receiving coils, An integrated circuit belonging to the pedal travel sensor 52 is contained on the printed circuit board 40. The second pedal travel detection unit 156 forms a unit, redundant with respect to the first pedal travel detection unit 153, for the detection of a pedal deflection. Therefore, the brake module 1 operates reliably even if the first pedal travel detection unit 153 should fail during operation. The brake module 1 can also be designed in such a way that the first pedal travel detection unit 153 is the redundant unit.

The first and the second pedal travel sensor 52, 55 are arranged next to one another, for example orientated at a spacing from one another in each case along parallel to the linear movement direction L of the guide element 90, with the result that they can detect a linear movement of the guide element 90 or of the pedal travel transducer 172. Correspondingly, the pedal travel transducer 172 is arranged in such a way that it moves along the first pedal travel sensor 52 and the second pedal travel sensor 55 in the case of a linear movement of the guide element 90. The pedal travel transducer 172 is correspondingly so wide that it covers the two pedal travel sensors 52, 55.

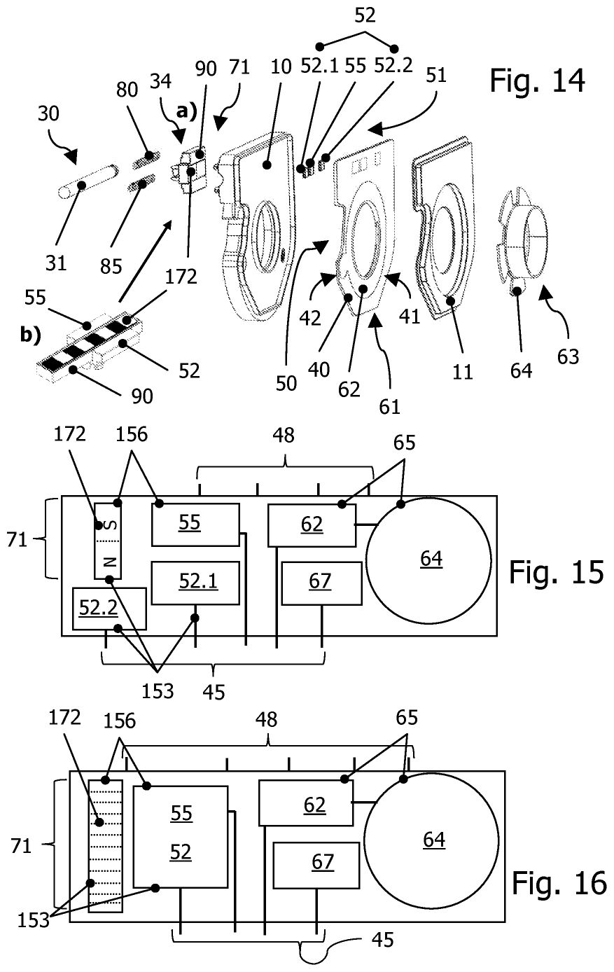

FIGS. 14, 15 and 16 show further variants of the second aspect of the disclosure, The variant, in the case of which the pedal travel transducer arrangement 71 is labelled by a) in FIG. 14, is assigned to the block diagram of FIG. 15. The variant, in the case of which the pedal travel transducer arrangement 71 is labelled by b) in FIG. 14, is assigned to the block diagram of FIG. 16.

In the case of the two variants FIG. 14 a) with FIG. 15 and FIG. 14 b) with FIG. 16, the above-described linear guide configuration comes into effect. In the case of the two variants, the arrangement, the construction and the type of printed circuit board 40, connectors 45, 48, housing cover 11, microswitch 67, rotor position sensor arrangement 61 and rotor position transducer arrangement 63 and the method of operation of the rotor position detection unit 65 are also identical to the variant described above on the basis of FIGS. 8 and 9, and have the same effects and advantages in relation thereto.

In the case of the variant FIG. 14 a) with FIG. 15, the guide element 90 supports a pedal travel transducer 172. The pedal travel transducer 172 is a permanent bipolar magnet. The pedal travel sensor arrangement 51 has a first pedal travel sensor 52 and a second pedal travel sensor 55. The sensors are arranged so as to follow one another along a parallel with respect to the linear movement direction L of the guide element. The first pedal travel sensor 55 is formed from two individual sensors 54.1 and 54.2 which are arranged along the parallel at a spacing from one another. The second pedal travel sensor is arranged between the individual sensors 54.1 and 54.2. In the direction of the thrust force S, first of all the individual sensor 54.1 is situated on the printed circuit board 40, and immediately following this is arranged the second pedal travel sensor 55. The individual sensor 54.2 is arranged at a spacing from the second pedal travel sensor 55.

The first pedal travel sensor 52 and the pedal travel transducer 172 together form a first pedal travel detection unit 153 which operates in accordance with the Hall principle. The first pedal travel sensor 52, that is to say the individual sensors 54.1 and 54.2, accordingly has in each case an electrode arrangement for utilizing the Hall effect. An integrated circuit belonging to the pedal travel sensor 52 is contained on the printed circuit board 40.

The second pedal travel sensor 55 and the pedal travel transducer 172 together form a second pedal travel detection unit 156 which operates in accordance with the Hall effect. The second pedal travel sensor 55 accordingly has an electrode arrangement for utilizing the Hall effect. An integrated circuit belonging to the pedal travel sensor 55 is contained on the printed circuit board 40. The second pedal travel detection unit 156 forms a unit, redundant with respect to the first pedal travel detection unit 153, for the detection of a pedal deflection. Therefore, the brake module 1 operates reliably even if the first pedal travel detection unit 153 should fail during operation. A greater detection travel results for the first pedal travel detection unit 153 as a result of the two individual sensors 54.1 and 54.2 which are spaced apart from one another than in the case of the second redundant pedal travel detection unit 156. The detection travel of the first pedal travel detection unit 153 depicts a great brake pedal deflection and ensure satisfactory handling of the brake module 1, since the brakes can be actuated in a finely metered manner by way of a great brake pedal travel. The redundant pedal travel detection unit 156 forms a smaller detection travel which is sufficient as redundancy function, however. The number of parts is reduced by way of the restriction to a second sensor which is not formed from a plurality of individual sensors, which has a favourable effect on production costs and handling capability.

In the case of the variant FIG. 14 b) with FIG. 16, the guide element 90 supports a pedal travel transducer 172. The pedal travel transducer 172 is a permanent multipolar magnet. The pedal travel sensor arrangement 51 has a first pedal travel sensor 52 and a second pedal travel sensor 55. The two pedal travel sensors 52 and 55 are arranged spaced apart from one another on the printed circuit board 40 in such a way that the pedal travel transducer can be guided between them along the linear movement direction L of the guide element. The poll pairs which are arranged multiple times behind one another on the pedal travel transducer 172 provide the magnetic field signals for the detection of the brake pedal deflection, which magnetic field signals can be detected by the pedal travel sensors. The first pedal travel sensor 52 and the pedal travel transducer 172 together form a first pedal travel detection unit 153 which operates in accordance with the Hall principle. The second pedal travel sensor 55 and the pedal travel transducer 172 together form a second pedal travel detection unit 156 which operates in accordance with the Hall principle. The second pedal travel detection unit 156 forms a unit, redundant with respect to the first pedal travel detection unit 153, for the detection of a pedal deflection. Therefore, the brake module 1 operates reliably even if the first pedal travel detection unit 153 should fail during operation.

1. An electrohydraulic brake module for a motor vehicle brake system, comprising
a housing,
a hydraulic module with a piston/cylinder arrangement for generating a hydraulic brake pressure,
an electric motor for driving the piston/cylinder arrangement,
a transmission arrangement for mechanically transmitting a brake pedal deflection,
a pedal travel transducer arrangement which is coupled to the transmission arrangement and is guided or mounted in the housing, with a first mechanism element and a second mechanism element,
a printed circuit board which is connected to the housing, with a sensor cluster which has a pedal travel sensor arrangement,
the pedal travel transducer arrangement having a first pedal travel transducer, the pedal travel sensor arrangement having a first pedal travel sensor, the first pedal travel transducer and the first pedal travel sensor together forming a first pedal travel detection unit which electronically detects the brake pedal deflection during operation,
the pedal travel transducer arrangement having a second pedal travel transducer, the pedal travel sensor arrangement having a second pedal travel sensor, the second pedal travel transducer and the second pedal travel sensor together forming a second pedal travel detection unit which electronically detects the brake pedal deflection during operation in a redundant manner with respect to the first pedal travel detection unit,
the first mechanism element establishing a force flow between the transmission arrangement and the housing in the case of a brake pedal actuation, and the second mechanism element establishing a force flow between the transmission arrangement and the housing in a redundant manner with respect to the first mechanism element in the case of a brake pedal actuation.

2. The electrohydraulic brake module according to claim 1, wherein the pedal travel transducer arrangement comprises a guide element which is coupled to the transmission arrangement and which is operatively connected to the first and the second mechanism elements and establishes a force flow between the transmission arrangement and the housing.

3. The electrohydraulic brake module according to claim 2, wherein the guide element is guided such that it can be moved linearly in the housing, and supporting the first and the second pedal travel transducers,
wherein the transmission arrangement has a thrust rod which is guided such that it can be moved linearly, acts on the guide element with a thrust force in the case of a brake pedal actuation, and is connected via a connecting point to the guide element in such a way that a thrust movement of the thrust rod can be forwarded into a linear movement of the guide element, and
wherein the first and the second mechanism element in each case being a spring, which acts between the housing and the guide element with a restoring force which acts counter to the thrust force,
wherein the springs are arranged in each case in such a way that their respective lines of action run parallel to a linear movement direction of the guide element.

4. The electrohydraulic brake module according to claim 3, wherein the first spring is prestressed in a rest position of the guide element.

5. The electrohydraulic brake module according to, claim 1, wherein the first pedal travel detection unit is a pedal travel detection unit which detects in accordance with an inductive sensor principle, and the second pedal travel detection unit is a pedal travel detection unit which detects in accordance with a Hall sensor principle.

6. The Electrohydraulic brake module according to claim 2, wherein the guide element is of annular configuration, with a gearwheel toothing system at least in sections, and being mounted rotatably in the housing,
wherein the transmission arrangement has a push-pull rod which is guided such that it can be moved linearly, acts on the guide element alternatively with a thrust and pulling force in a case of a brake pedal actuation, and is connected via a connecting point to the guide element in such a way that a thrust movement of the push/pull rod is converted into a rotational movement of the guide element,
wherein the first and the second mechanism element are in each case of wheel-shaped configuration, and being mounted in each case in a stationary and a rotatable manner in the housing by way of a cover element,
wherein the first and the second mechanism element are positioned next to one another in the housing in such a way that they in each case form a gear mechanism, with the guide element of annular configuration and its gearwheel toothing system, and
wherein the first mechanism element supports the first pedal travel transducer, and the second mechanism element supports the second pedal travel transducer.

7. The electrohydraulic brake module according to claim 6,
wherein the connecting point being such that, together with the push/pull rod, forms a cross-slider crank mechanism, in which the annular guide element has a slotted guide and the push/pull rod has a pin which is guided in the slotted guide.

8. The electrohydraulic brake module according to claim 6, the first and the second pedal travel detection unit in each case being a pedal travel detection unit which detects in accordance with a magneto-resistive sensor principle.

9. An electrohydraulic brake module for a motor vehicle brake system, comprising:
a housing,
a hydraulic module with a piston/cylinder arrangement for generating a hydraulic brake pressure,
an electric motor for driving the piston/cylinder arrangement,
a transmission arrangement for mechanically transmitting a brake pedal deflection,
a pedal travel transducer arrangement which is coupled to the transmission arrangement and is guided or mounted in the housing, with a first mechanism element and a second mechanism element,
a printed circuit board which is connected to the housing, with a sensor cluster which has a pedal travel sensor arrangement,
wherein the pedal travel transducer arrangement has a pedal travel transducer, the pedal travel sensor arrangement having a first pedal travel sensor, the pedal travel transducer and the first pedal travel sensor together forming a first pedal travel detection unit which electronically detects the brake pedal deflection during operation,
the pedal travel sensor arrangement having a second pedal travel sensor, the pedal travel transducer and the second pedal travel sensor together forming a second pedal travel detection unit which electronically detects the brake pedal deflection in a redundant manner with respect to the first pedal travel detection unit during operation,
wherein a first mechanism element establishes a force flow between the transmission arrangement and the housing in a case of a brake pedal actuation, and a second mechanism element establishing a force flow between the transmission arrangement and the housing in a redundant manner with respect to the first mechanism element in the case of a brake pedal actuation.

10. The electrohydraulic brake module according to claim 9, wherein the pedal travel transducer arrangement comprises a guide element which is coupled to the transmission arrangement, and which is operatively connected to the first and the second mechanism element and establishes a force flow between the transmission arrangement and the housing.

11. The electrohydraulic brake module according to claim 10, wherein
the guide element is guided in the housing such that it can be moved linearly,
the guide element supports the pedal travel transducer,
the transmission arrangement having a thrust rod which is guided such that it can be moved linearly, act with a thrust force on the guide element in the case of a brake pedal actuation, and is connected via a connecting point to the guide element in such a way that a thrust movement of the thrust rod can be forwarded into a linear movement of the guide element, and
the first and the second mechanism element in each case being a spring, which acts between the housing and the guide element with a restoring force which acts counter to the thrust force,
the springs being arranged in each case in such a way that their respective lines of action run parallel to a linear movement direction of the guide element.

12. The electrohydraulic brake module according to claim 9, wherein
the first and the second pedal travel detection unit in each case being a pedal travel detection unit which detects in accordance with a inductive sensor principle, or
the first and the second pedal travel detection unit in each case being a pedal travel detection unit which detects in accordance with a Hall sensor principle and in the case of which the pedal travel transducer is a permanent bipolar magnet, or
the first and the second pedal travel detection unit in each case being a pedal travel detection unit which detects in accordance with the Hall sensor principle and in the case of which the pedal travel transducer is a permanent multipolar magnet.

13. The electrohydraulic brake module according to claim 9, wherein
the first and the second pedal travel detection unit in each case being a pedal travel detection unit which detects in accordance with a Hall sensor principle, and the pedal travel transducer being a permanent bipolar magnet,
the first pedal travel sensor having two individual sensors which are arranged in a row in the movement direction of the pedal travel transducer arrangement, and
it being possible for the first pedal travel sensor to detect a greater movement travel of the pedal travel transducer arrangement than the second pedal travel sensor.

14. An electrohydraulic brake module according to claim 1, wherein
the electrohydraulic brake module having a rotor position transducer arrangement with a rotor position transducer,
the sensor cluster having a rotor position sensor arrangement with a rotor position sensor, and
the rotor position transducer and the rotor position sensor together forming a rotor position detection unit which detects in accordance with an inductive sensor principle, which rotor position detection unit electronically detects the rotor position of the rotor of the electric motor during operation.

15. The electrohydraulic brake module according to claim 14, wherein
the rotor position sensor arrangement is arranged on a first side of the printed circuit board, and the pedal travel sensor arrangement and a microswitch being arranged on a second side of the printed circuit board opposite the first side.

16. The electrohydraulic brake module according to claim 15, wherein
the sensor cluster comprises the microswitch with a switching lever, for activating the electrohydraulic brake module and/or other systems in a vehicle from a rest state and/or for activating a vehicle brake light,
the microswitch being arranged on the second side.

17. The electrohydraulic brake module according to claim 1, wherein the electrohydraulic brake module, having an electronic interface for transmitting digital signals to an electronic control unit, for controlling the electric motor.

18. The electrohydraulic brake module according to claim 1, wherein the first and the second pedal travel detection units in each case are pedal travel detection units which detect in accordance with an inductive sensor principle.

19. The electrohydraulic brake module according to claim 1, wherein the first and the second pedal travel detection units in each case are pedal travel detection units which detect in accordance with a Hall sensor principle.
